(19) United States
(12) Patent Application Publication
(10) Pub. No.: US 2007/0005553 A1
(43) Pub. Date: Jan. 4, 2007

(54) System for composite instrumented resource data

(76) Inventors: Ravi Sahita, Beaverton, OR (US); Priya Govindarajan, Hillsboro, OR (US); Surekha Poola, Portland, OR (US)

Correspondence Address: BUCKLEY, MASCHOFF, TALWALKAR LLC, 50 LOCUSTAVENUE, NEW CANAAN, CT, 06840, US

(21) Appl. No.: 11/171,575

(22) Filed: Jun. 30, 2005

(51) Int. Cl. G06F 17/30

(52) U.S. Cl. 707/1

(57) ABSTRACT

According to some embodiments, a first resource data record is discovered, the first resource data record indicating a first memory location of first executable program code, a second resource data record indicating a second memory location of first managed resource data of a first manageable resource, and a third resource data record indicating a third memory location of second managed resource data of a second manageable resource. The first program code is retrieved from the memory location, and is executed to retrieve the first managed resource data from the second memory location, to retrieve the second managed resource data from the third memory location, and to perform an operation on the first managed resource data and the second managed resource data.

### BACKGROUND

A conventional computing platform may include diagnostic code for managing a resource thereof. The diagnostic code may interact with scalars, counters, effectors and events that are instrumented by instrumentation code associated with the resource. Management of the resource therefore requires the diagnostic code to understand the semantics of the instrumented elements and to properly interact therewith.

The foregoing requirement may be difficult to fulfill, particularly if diagnostic code is intended to manage several different resources of a particular type (e.g., Network Interface Card device drivers produced by several different vendors). In such a case, each different resource may be associated with instrumentation code that instruments different sets of scalars, counters, effectors and events, and/or instruments similar scalars, counters, effectors and events but which have different semantics. Systems are desired to efficiently abstract one or more instrumented elements to facilitate interaction therewith.

### BRIEF DESCRIPTION OF THE DRAWINGS

FIG. 1 is a block diagram of a system according to some embodiments.

FIG. 2 is a detailed block diagram of a system according to some embodiments.

FIG. 3 illustrates a Resource Data Record format according to some embodiments.

FIG. 4 illustrates an association-type Resource Data Record format according to some embodiments.

FIG. 5 illustrates an event-type Resource Data Record format according to some embodiments.

FIG. 6 is a flow diagram according to some embodiments.

FIG. 7 is a diagram illustrating operation of a system according to some embodiments.

FIG. 8 is a block diagram of a system according to some embodiments.

### DETAILED DESCRIPTION

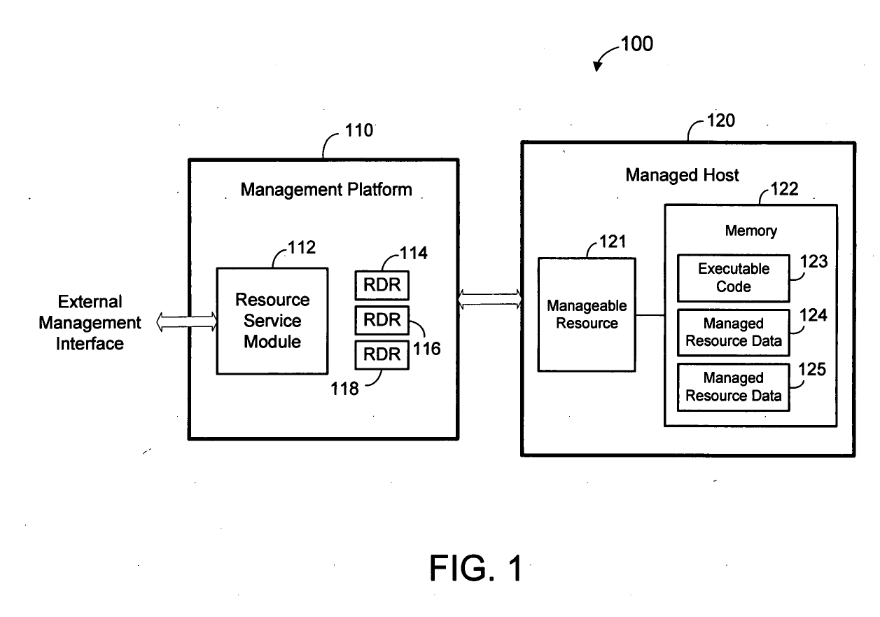

FIG. 1 illustrates system 100 according to some embodiments. System 100 includes management platform 110 and managed host 120. Management platform 110 may interact with managed resource data instrumented by managed host 120 in order to manage managed host 120.

In one example of operation, resource service module 112 of management platform 110 discovers resource data record (RDR) 114. RDR 114 indicates a location of executable code 123 in memory 122 of managed host 120. RDR 114 also indicates RDR 116 and RDR 118. RDR 116, in turn, indicates a location of managed resource data 124 in memory 122, where managed resource data 124 is associated with (and/or instrumented by) manageable resource 121 of managed host 120. RDR 118 indicates a location of managed resource data 125 in memory 122, where managed resource data 125 is also associated with manageable resource 121.

Using the information provided by RDR 114, management platform 110 may retrieve and execute code 123 to retrieve managed resource data 124 from memory 122 and to retrieve managed resource data 125 from memory 122. Management platform 110 may also execute code 123 to perform an operation on managed resource data 124 and managed resource data 125. In some embodiments, the foregoing process commences in response to a request received by resource service module 112 from a system management module (not shown) via an external management interface. Accordingly, a result of the operation may be passed from resource service module 112 to the requesting system management module via the external management interface.

Some embodiments of the foregoing may allow software vendors to introduce layers of intelligence between system management modules on management platforms and the dispersed instrumentation data available via instrumented hardware or software resources of a managed host. These layers of intelligence may abstract the instrumentation data to a smaller, more coherent, and/or standard set of instrumentation data to enhance the manageability of the resources and allow for consistent access control.

Management platform 110 may comprise any one or more execution units including, but not limited to, a processor, a co-processor, a controller, one or more microengines of a network processor, a virtual machine, a logical partition, and a firmware extension. In some embodiments, management platform 110 may manage hardware and software resources of managed host 120 independent of an operating system environment provided by managed host 120.

In this regard, management platform 110 may provide an operating environment and memory separate those of managed host 120. Accordingly, some embodiments of management platform 110 may manage host 120 before boot, after shutdown, or post-crash of the operating system environment of managed host 120. The separate environment may provide security advantages over a management service running local to host 120. Specifically, a management service running on host 120 can be more easily compromised by a virus or worm attack if other resources on host 120 are compromised.

Managed host 120 may comprise any computing platform including one or more manageable resources. Managed host 120 may comprise a processor, a motherboard, a main memory, a chipset, a network interface card, other expansion cards, a power supply, a cooling system, and/or any other hardware components. Managed host 120 may also execute program code of an operating system, applications, and other device drivers. Any hardware, firmware and software components of managed host 120 may comprise manageable resource 121.

As alluded to above, a manageable resource may be associated with managed resource data comprising one or more sensors, effectors and events. For example, a fan's speed and a processor's temperature may comprise sensors associated with a fan resource and a processor resource, respectively. A packet count may comprise a sensor associated with a device driver for a network interface card. Values associated with the managed resource data may be stored in memory 122 by instrumentation code associated with manageable resource 121.

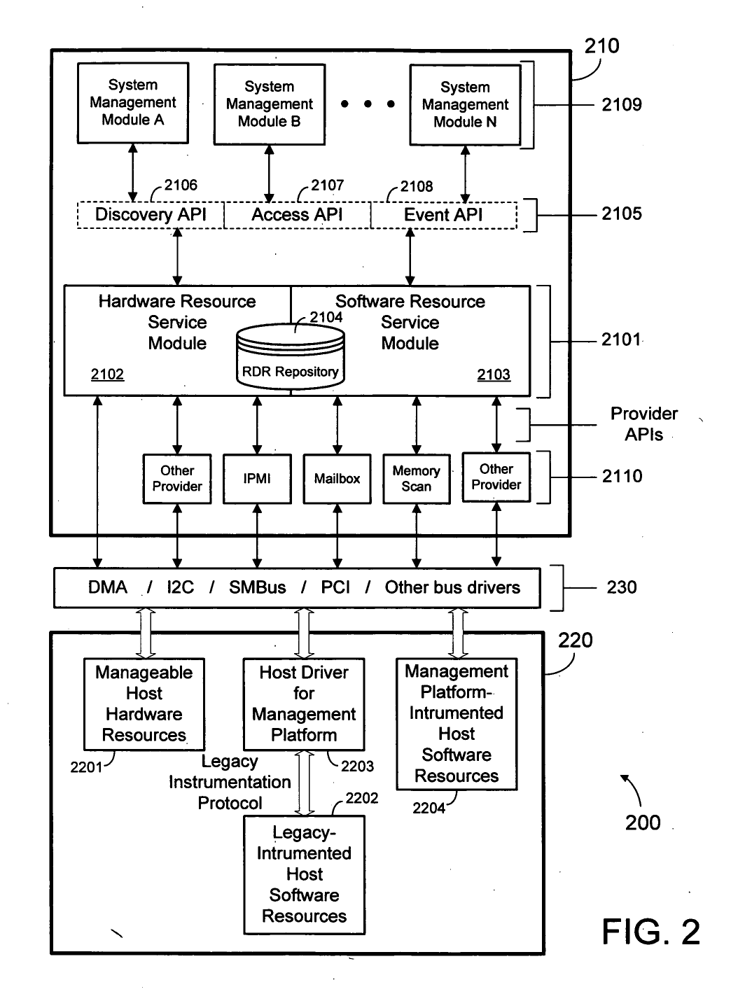

FIG. 2 comprises a detailed diagram of system 200 according to some embodiments. Management platform 210 and managed host 220 of system 200 comprise particular instantiations of management platform 110 and managed host 120 of FIG. 1. Accordingly, some embodiments of system 200 may provide the functions described above with respect to system 100. The elements of platform 210 and host 220 may be embodied as services, layers, and/or core components of an associated operating environment, and may be embodied as any other executable software component, including a dynamic link library, a static library, or a stand-alone application.

Management platform 210 includes core 2101 comprising hardware resource service module 2102, software resource service module 2103 and RDR repository 2104. Core 2101 exposes external interface 2105, which includes Discovery application programming interface (API) 2106, Access API 2107, and Event API 2108. System management modules 2109 executing on management platform 210 invoke interface 2105 to read sensors, configure effectors, and subscribe to events associated with manageable resources of managed host 220.

System management modules 2109 may use Discovery API 2106 to dynamically discover the manageable resources present in managed host 220. Such discovery allows modules 2109 to then invoke Access API 2107 to query for managed resource data associated with resources with which they wish to interact. Event API 2108 constitutes a set of APIs that would be used to subscribe to host-generated events and to publish events.

One or more of system management modules 2109 may comprise executable code such as executable code 123 of FIG. 1. Accordingly, one of these modules 2109 may be associated with a respective RDR in repository 2104. If another module 2109 accesses the RDR using Access API 2107, the one module 2109 may be executed to access managed resource data associated with two or more other RDRs.

Resource service modules 2102 and 2103 handle sensor read/effector write/event subscription requests that are received via external interface 2105. Hardware resource service module 2102 interacts with managed resource data associated with manageable hardware resources 2201 on managed host 220 in response to invocations of interface 2105. Hardware resource service module 2102 may-comply with existing protocols (e.g., Hardware Platform Interface, Intelligent Platform Management Interface) to interact with these resources either directly via an appropriate one of providers 2110 or via one of bus drivers 230.

Software resource service module 2103 interacts with managed resource data associated with manageable software resources of host 220. Examples include network statistics associated with a network device driver, hard disk statistics associated with a hard disk driver, etc. Manageable software resources may comprise legacy-instrumented host software resources 2202 with which platform 210 interacts using corresponding platform software driver 2203, and/or host software resources 2204 that are instrumented in view of management platform 210 and may therefore directly interact therewith.

Modules 2102 and 2103 of core 2101 interact with manageable resources of host 220 via providers 2110. More particularly, modules 2102 and 2103 may use providers 2110 to access transport mechanisms of host 220 in order to reach managed resource data stored therein. Each of providers 2110 may abstract low-level communication with one or more corresponding bus drivers 230 to a single provider API. For example, mailbox provider 2110 may expose a mailbox provider API to core 2101 for communication between core 2101 and two or more bus protocols. The number and type of providers in a given implementation of platform 210 may vary among embodiments.

Resource service modules 2102 and 2103 are also responsible for discovering manageable resources on host 220. The discovered resources (specified in the form of RDRs) are stored in RDR repository 2104. RDRs may be used to provide a consistent mechanism for describing manageable resources, their relationships, and the operations that can be performed thereon. As mentioned with respect to FIG. 1, an RDR may be associated with executable code (e.g., a system management module 2109) for accessing and performing an operation on managed resource data that is described by two other RDRs.

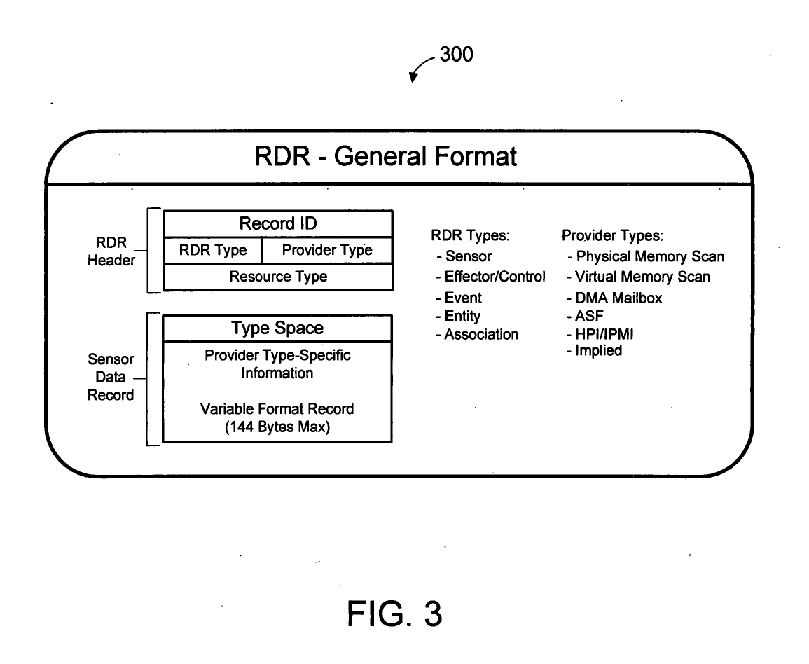

FIG. 3 is a representation of RDR 300 to illustrate a general RDR format according to some embodiments. RDR 300 may describe managed resource data of a managed host. 5 The description may include data type (i.e., RDR type) of the managed resource data, and type of provider used to access the managed resource data (i.e., provider type), The specified resource type identifies a specific sensor, control, event, etc. which comprises the RDR.

Generally, a sensor RDR describes a resource capable of reading operational or health data (e.g. fan speed or Network Interface Card (NIC) statistics), an effector RDR describes a resource capable of platform control (e.g. powering on a fan or enabling a NIC's auto-negotiation feature), an event RDR describes a resource's capability to generate asynchronous events, and an association RDR describes an association between two other RDRs. Sensor, effector, event, and association RDRs may logically belong to a “parent” entity RDR that identifies an associated manageable resource.

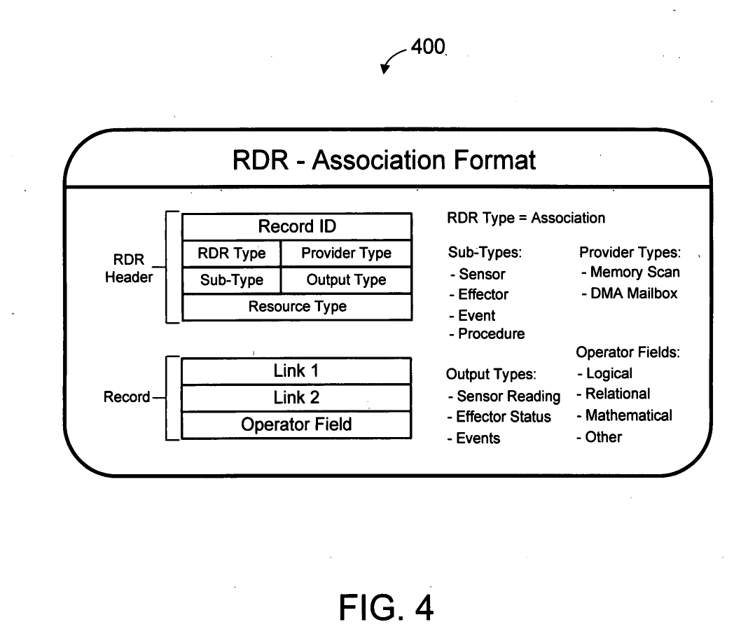

FIG. 4 is a representation of RDR 400 to illustrate a format of an association RDR according to some embodiments. RDR 400 may describe a logical relationship between any two individual RDRs associated with managed resource data of a managed host. As above, RDR 400 specifies RDR type (i.e., association), provider type, and resource type. RDR 400 also specifies a sub-type (e.g., sensor, effector, event, or procedure) and an output type (e.g., sensor reading, effector status, or events).

The link 1 and link 2 fields of RDR 400 indicate two other RDRs with which RDR 400 is associated. The other RDRs may be associated with respective managed resource data. In a case that RDR 400 specifies a procedure sub-type, the operator field indicates a memory location of executable code. The executable code is to perform an operation on the managed resource data associated with the two other RDRs. A detailed example involving a procedure-type association RDR is provided below

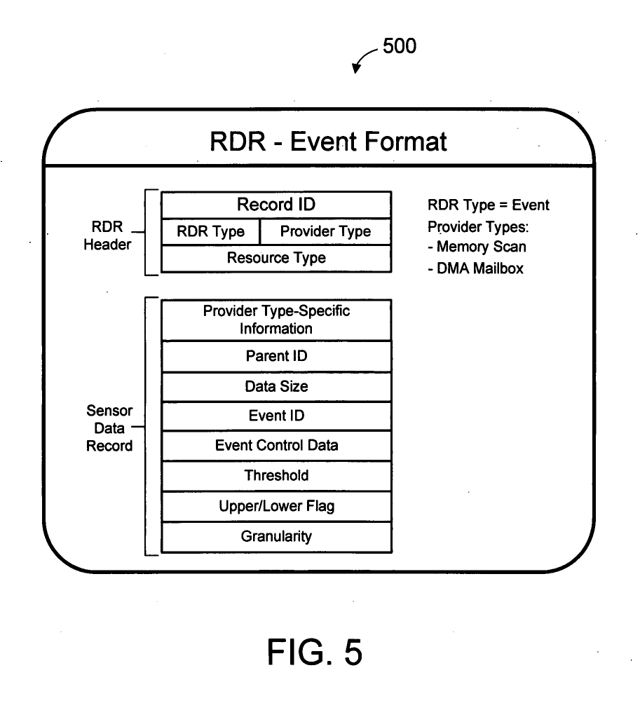

FIG. 5 is a representation of RDR 500 to illustrate a format of an event RDR according to some embodiments. RDR 500 may describe a managed resource's ability to generate asynchronous events. RDR 500 specifies RDR type (i.e., event), provider type, and resource type. In some embodiments, RDR 500 also provides additional fields of information to describe such an asynchronous event. These fields describe a parent entity RDR (parent ID), a size of the issued event data (data size), an identifier of the event (event ID), and event control data.

The threshold field of RDR 500 indicates a threshold value and upper/lower flag field indicates whether the threshold value is an upper threshold or a lower threshold. Accordingly, an event associated with RDR 500 is generated if a subject value falls below a lower threshold or surpasses an upper threshold. The granularity field indicates how far below a lower threshold or above an upper threshold a value must pass before the event is generated.

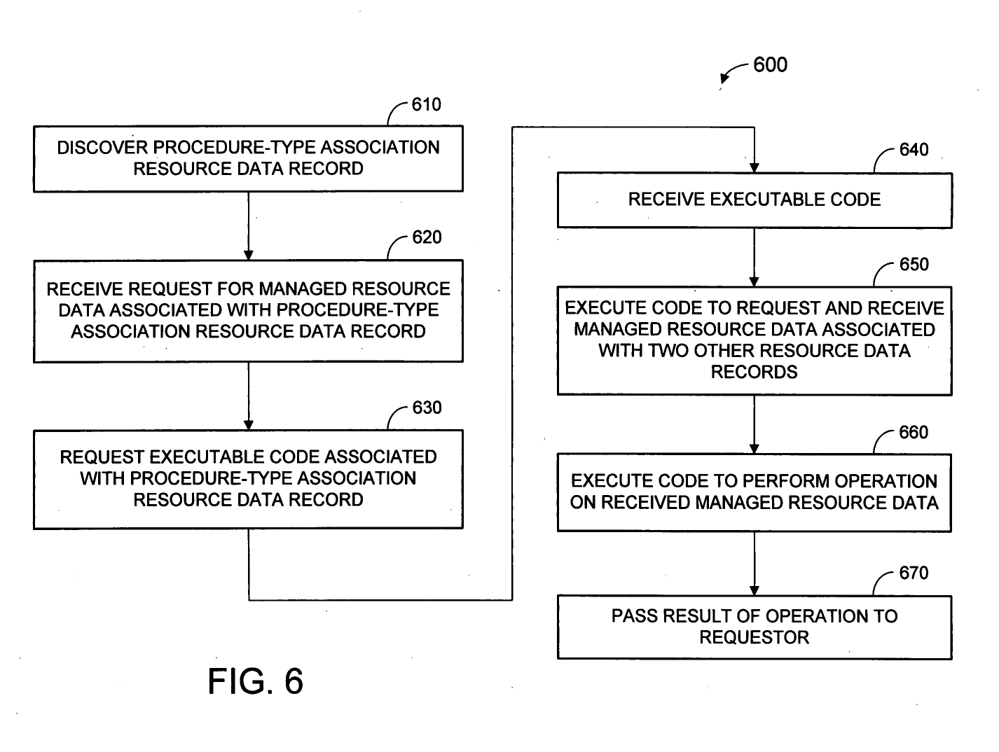

FIG. 6 is a flow diagram of method 600 according to some embodiments. Method 600 may be executed by, for example, systems such as systems 100 and/or 200. Any of the methods described herein may be performed by hardware, software (including microcode), or a combination of hardware and software. For example, an execution unit may be operative in conjunction with program code stored on a storage medium to perform methods according to any of the embodiments described herein.

Initially, at 610, a procedure-type association RDR is discovered. According to some embodiments of method 600, software resources 2202 of managed host 220 register associated managed resource data at 610 using an existing operating system-specific management instrumentation protocol. Host management driver 2203 then queries the protocol framework to identify the available managed resource data. In the case of the Windows Management Instrumentation (WMI) protocol, such a query may comprise a query for all registered Globally Unique IDs. Host management driver 2203 then constructs an RDR repository in host memory based on the results of the query and on a pre-configured mapping between the operating-specific management instrumentation data type and the RDR type spaces.

Host management driver 2203 transmits a registration message through bus 230 and providers 2110 to core 2101 via a mailbox protocol to indicate that initialization is complete. In response to the message, core 2101 queries host management driver 2203 for the RDR repository in host memory. Host management driver 2203 then returns the RDRs of the repository to core 2101 in response to the query.

At least one of the RDRs is a procedure-type association RDR. The procedure-type association RDR may identify a memory location of managed host 220 in which executable code is stored. The procedure-type association RDR also indicates two other RDRs. Moreover, the executable code is to retrieve managed resource data associated with the other two RDRs and to perform an operation on the retrieved managed resource data.

The above-described embodiment for RDR exposition and discovery utilizes operating system-specific management instrumentation protocols implemented by a software resource (e.g., software resources 2202) as well as a host management driver to map operating-specific management instrumentation data type to RDR type spaces. Some embodiments, on the other hand, may provide discovery of manageable resources and associated RDRs without such prerequisites.

For example, one of management platform-instrumented software resources 2204 may allocate a host driver Direct Memory Access (DMA) window in host memory at 610. The window may comprise a contiguous, page-aligned and non-cached memory location. The resource 2204 may then update the DMA window with resource-related information. The information may include a pre-defined marker identifying the window and RDRs associated with the resource 2204. The RDRs may include a procedure-type association RDR as described above. Accordingly, the executable code associated with the procedure-type association RDR may be provided by a vendor of the resource 2204 and may be used to abstract the managed resource data associated with the two RDRs indicated by the procedure-type association RDR.

The resource 2204 generates a resource ID and passes the ID and the address of the DMA window to core 2101 via mailbox provider 2110. Core 2101 then issues a command to scan the DMA window at the DMA window address. Memory scan provider 2110 scans the DMA window to retrieve data therefrom. The data comprise RDRs such as RDRs 114 through 118, and are stored in RDR repository 2104 in association with the resource ID.

A request for managed resource data is received at 620. The request may be received from a system management module via an external interface. As an example, software resource service module 2103 may receive a request from system management module A via Access API 2107. The request may request access to managed resource data exposed by software resource service module 2103. In the present example, a procedure-type association RDR of repository 2104 includes a record ID that corresponds to the managed resource data. The managed resource data therefore comprises the result of an operation performed on at least two other managed resource data.

Executable code associated with the procedure-type association RDR is requested at 630. In some embodiments, software resource service module 2103 includes logic to request such executable code if a received request corresponds to a procedure-type association RDR. The RDR specifies a type of provider 2110 needed to access the code, and a memory location of managed host 220 in which the code is stored. The managed resource data may be received from the specified memory location using the specified provider at 640.

The received code is executed at 650 to request and receive managed resource data associated with two other RDRs. The code may comprise scripts executed by a virtual machine of management platform 210, native code for the operating environment of platform 210, or any other suitable executable code. The two other RDRs comprise the RDRs identified in the procedure-type association RDR as described with respect to FIG. 4.

In some embodiments of 650, the received code is executed to request and receive managed resource data associated with the two other RDRs using mechanisms available to system management modules 2109. That is, software resource service module 2103 receives the request from the executable code via Access API 2107. The RDRs are identified based on the request, indicate memory locations of managed host 220 in which the requested managed resource data are stored, and specify provider types needed to access the data. The managed resource data are then retrieved from the indicated memory locations at 650 using the specified providers.

The code is further executed at 660 to perform an operation on the managed resource data received at 650. Any currently- or hereafter-known operation may be performed at 660. A result of the operation may be an event, a sensor value, or any other element that may be considered managed resource data. The result is passed to the requesting system management module at 670. According to some embodiments, management platform 210 may execute the code to pass the result to the requesting system management module 2109 in a callback to the interface of Access API 154 that was invoked at 620.

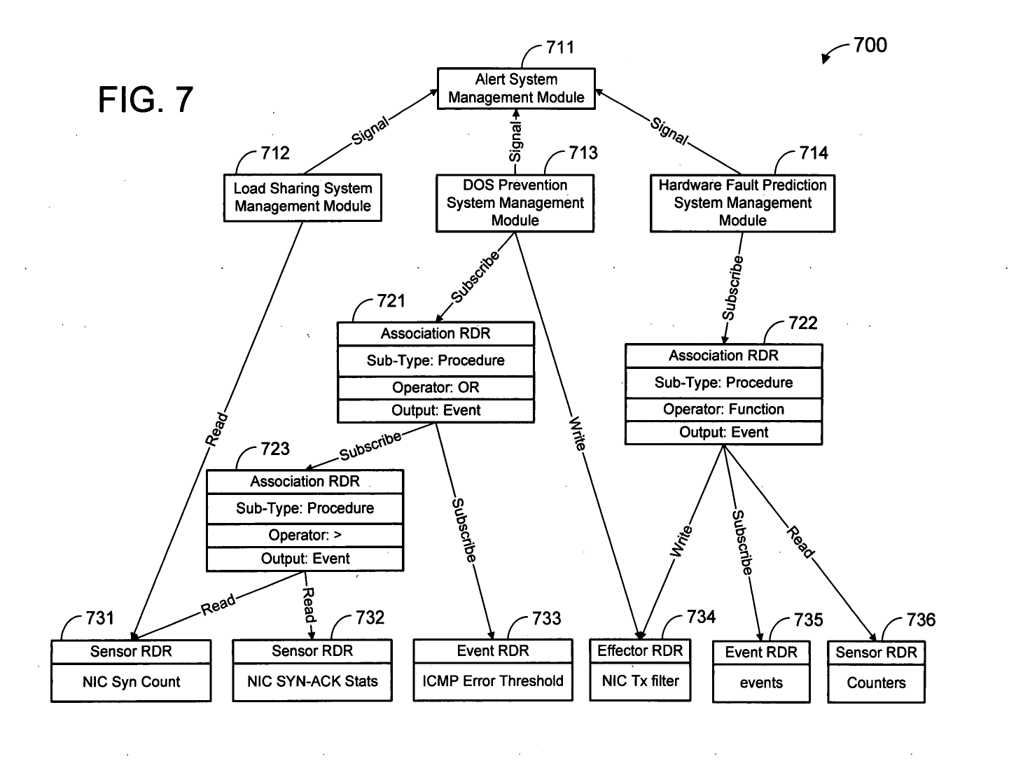

System 700 of FIG. 7 illustrates interactions between system management modules 711 through 714, procedure-type association RDRs 721 through 723, and other RDRs 731 through 736 according to some embodiments of method 600. As shown, alert system management module 711 communicates with system management modules 712, 713 and 714 to interact with managed resource data associated with RDRs 731 through 736. To do so, some system management modules (i.e., modules 712 and 713) directly access managed resource data through their associated RDRs (i.e., RDRs 731 and 734) as described with respect to 650.

System management modules 713 and 714 access procedure-type association RDRs 721 and 722, respectively. Such access may proceed as described with respect to method 600. As shown, procedure-type association RDR 723 is accessed by executable code corresponding to procedure-type association RDR 721. That is, RDR 721 indicates a memory location of the executable code and further indicates RDR 723 and RDR 733. RDR 723 therefore appears to the executable code of RDR 721 as any other RDR that is associated with managed resource data.

In operation, executable code associated with RDR 723 therefore performs an operation on managed resource data associated with RDRs 731 and 732, and publishes a result of the operation to executable code associated with RDR 721. The executable code associated with RDR 721 also receives managed resource data published by RDR 733 and performs an operation based thereon and on the result received from the code associated with RDR 723. A result of the latter operation is then published and received by system management module 713. The results and managed resource data are described above as being “published” because event RDRs 721, 723 and 733 transmit data using a publish/subscribe protocol.

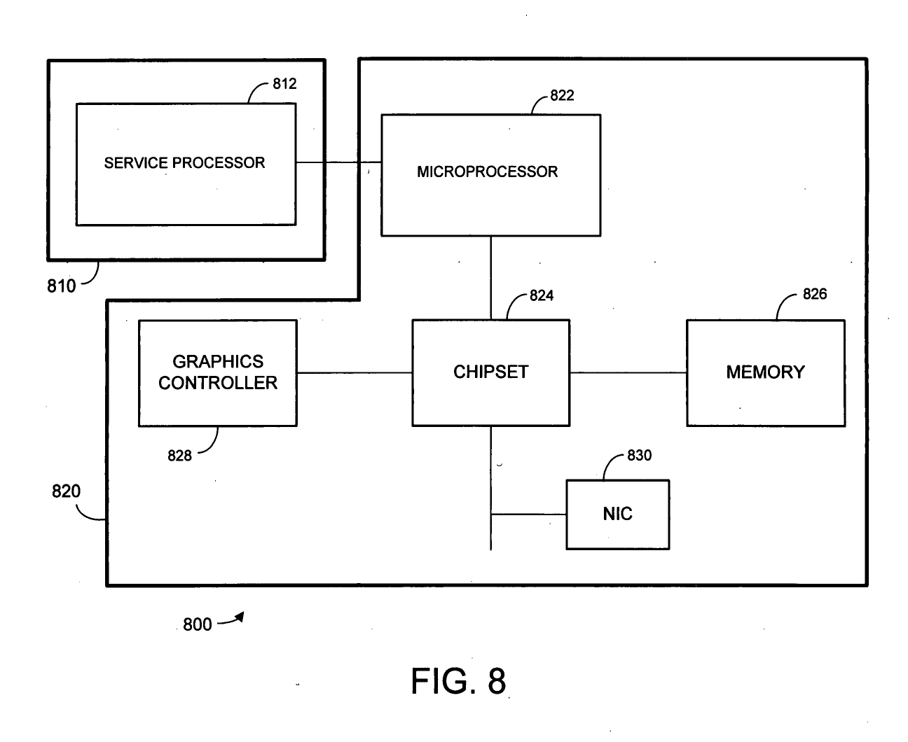

FIG. 8 illustrates a block diagram of system 800 according to some embodiments. System 800 includes management platform 810 and managed host 820. Management platform 810 includes service processor 812 which may execute functions attributed to a management platform herein. Managed host 820 comprises microprocessor 822, which may execute host software (e.g., device drivers, host management driver, etc.). Managed host 820 also includes chipset 824 and host memory 826. Host memory 826 may comprise any suitable type of memory, including but not limited to Single Data Rate Random Access Memory and Double Data Rate Random Access Memory. Other functional units of managed host 820 include graphics controller 828 and Network Interface Controller (NIC) 830, each of which may communicate with microprocessor 822 via chipset 824.

The several embodiments described herein are solely for the purpose of illustration. Therefore, persons in the art will recognize from this description that other embodiments may be practiced with various modifications and alterations.

What is claimed is:

1. A medium storing code providing:
first executable program code;
a first resource data record indicating a first memory location of the first executable program code;
a second resource data record indicating a second memory location of first managed resource data of a first manageable resource; and
a third resource data record indicating a third memory location of second managed resource data of a second manageable resource,
wherein the first resource data record further indicates the second resource data record and the third resource data record, and
wherein the first executable program code is executable to retrieve the first managed resource data from the second memory location, to retrieve the second managed resource data from the third memory location, and to perform an operation on the first managed resource data and the second managed resource data.

2. A medium according to claim 1, wherein the first executable program code is executable to:
receive a request from a requestor for managed resource data associated with the first resource data record; and
pass a result of the operation to the requester.

3. A medium according to claim 1, wherein the first manageable resource and the second manageable resource are identical.

4. A medium according to claim 1, wherein a managed host includes the memory location, the first manageable resource and the second manageable resource.

5. A medium according to claim 1,
wherein the first executable program code is executable to retrieve the second executable program code from the second memory location,
wherein the second resource data record indicates a fourth resource data record indicating a fourth memory location of third managed resource data of a third manageable resource, and a fifth resource data record indicating a fifth memory location of fourth managed resource data of a fourth manageable resource, and
wherein the first managed resource data comprises second executable program code, the second executable program code being executable to retrieve the third managed resource data from the fourth memory location, to retrieve the fourth managed resource data from the fifth memory location, to perform a second operation on the third managed resource data and the fourth managed resource data, and to pass a result of the second operation to the first program code.

6. A medium according to claim 5, further comprising:
receiving a request from a requestor for managed resource data associated with the first resource data record; and
passing a result of the operation to the requester.

7. A method comprising:
discovering a first resource data record, the first resource data record indicating a first memory location of first executable program code, a second resource data record indicating a second memory location of first managed resource data of a first manageable resource, and a third resource data record indicating a third memory location of second managed resource data of a second manageable resource;
retrieving the first program code from the memory location; and
executing the first program code to retrieve the first managed resource data from the second memory location, to retrieve the second managed resource data from the third memory location, and to perform an operation on the first managed resource data and the second managed resource data.

8. A method according to claim 7, further comprising:
receiving a request from a requestor for managed resource data associated with the first resource data record; and
passing a result of the operation to the requester.

9. A method according to claim 7, wherein the first manageable resource and the second manageable resource are identical.

10. A method according to claim 7, wherein a managed host includes the memory location, the first manageable resource and the second manageable resource.

11. A method according to claim 7, wherein the first managed resource data comprises second executable program code,
wherein the second resource data record indicates a fourth resource data record indicating a fourth memory location of third managed resource data of a third manageable resource, and a fifth resource data record indicating a fifth memory location of fourth managed resource data of a fourth manageable resource, the method further comprising:
retrieving the second executable program code from the second memory location; and
executing the second executable program code to retrieve the third managed resource data from the fourth memory location, to retrieve the fourth managed resource data from the fifth memory location, and to perform a second operation on the third managed resource data and the fourth managed resource data, and to pass a result of the second operation to the first program code.

12. A method according to claim 11, further comprising:
receiving a request from a requester for managed resource data associated with the first resource data record; and
passing a result of the operation to the requestor.

13. A management platform comprising:
a memory storing executable platform code; and
an execution unit operable in conjunction with the platform code to:
discover a first resource data record, the first resource data record indicating a first memory location of first executable program code, a second resource data record indicating a second memory location of first managed resource data of a first manageable resource, and a third resource data record indicating a third memory location of second managed resource data of a second manageable resource;
retrieve the first program code from the memory location; and
execute the first program code to retrieve the first managed resource data from the second memory location, to retrieve the second managed resource data from the third memory location, and to perform an operation on the first managed resource data and the second managed resource data.

14. A management platform according to claim 13, the execution unit further operable in conjunction with the platform code to:
receive a request from a requester for managed resource data associated with the first resource data record; and
pass a result of the operation to the requester.

15. A management platform according to claim 13, wherein the first manageable resource and the second manageable resource are identical.

16. A management platform according to claim 13, wherein a managed host includes the memory location, the first manageable resource and the second manageable resource.

17. A management platform according to claim 13, wherein the first managed resource data comprises second executable program code,
wherein the second resource data record indicates a fourth resource data record indicating a fourth memory location of third managed resource data of a third manageable resource, and a fifth resource data record indicating a fifth memory location of fourth managed resource data of a fourth manageable resource, and
wherein the execution unit is further operable in conjunction with the platform code to:
retrieve the second executable program code from the second memory location; and
execute the second executable program code to retrieve the third managed resource data from the fourth memory location, to retrieve the fourth managed resource data from the fifth memory location, to perform a second operation on the third managed resource data and the fourth managed resource data, and to pass a result of the second operation to the first program code.

18. A management platform according to claim 17, the execution unit further operable in conjunction with the platform code to:
receive a request from a requestor for managed resource data associated with the first resource data record; and
pass a result of the operation to the requestor.

19. A system comprising:
a processor;
a double data rate memory coupled to the processor;
a memory storing executable platform code; and
a service processor operable in conjunction with the platform code to:
discover a first resource data record, the first resource data record indicating a first memory location of first executable program code, a second resource data record indicating a second memory location of first managed resource data of a first manageable resource, and a third resource data record indicating a third memory location of second managed resource data of a second manageable resource;
retrieve the first program code from the memory location; and
execute the first program code to retrieve the first managed resource data from the second memory location, to retrieve the second managed resource data from the third memory location, and to perform an operation on the first managed resource data and the second managed resource data.

20. A system according to claim 19, the service processor further operable in conjunction with the platform code to:
receive a request from a requestor for managed resource data associated with the first resource data record; and
pass a result of the operation to the requestor.

21. A system according to claim 19, wherein the first managed resource data comprises second executable program code,
wherein the second resource data record indicates a fourth resource data record indicating a fourth memory location of third managed resource data of a third manageable resource, and a fifth resource data record indicating a fifth memory location of fourth managed resource data of a fourth manageable resource, and
wherein the service processor is further operable in conjunction with the platform code to:
retrieve the second executable program code from the second memory location; and
execute the second executable program code to retrieve the third managed resource data from the fourth memory location, to retrieve the fourth managed resource data from the fifth memory location, to perform a second operation on the third managed resource data and the fourth managed resource data, and to pass a result of the second operation to the first program code.

22. A system according to claim 21, the service processor further operable in conjunction with the platform code to:
receive a request from a requestor for managed resource data associated with the first resource data record; and
pass a result of the operation to the requestor.
